(19) United States
(12) Patent Application Publication
(10) Pub. No.: US 2026/0043428 A1
(43) Pub. Date: Feb. 12, 2026

(54) Sacrificial Plate, Fastening Device with such a Sacrificial Plate and Method for Fastening by Means of Such a Fastening Device

(71) Applicant: Illinois Tool Works Inc., Glenview, IL (US)

(72) Inventors: Hendrik Bobach, Hemmerheim (DE); Maria Deininger, Uffenheim (DE); Christoph Leidig, Neusitz (DE); Martin Kluge, Röttingen (DE); Jan Müller, Würzburg (DE)

(21) Appl. No.: 19/296,577

(22) Filed: Aug. 11, 2025

(30) Foreign Application Priority Data
Aug. 12, 2024 (DE) 10 2024 122 999.3
Aug. 7, 2025 (DE) 10 2025 131 484.5

(51) Int. Cl. F16B 9/02

(52) U.S. Cl. CPC F16B 9/02

(57) ABSTRACT

According to the disclosure, a sacrificial plate for plastic welding, in particular for a fastening apparatus for fastening a first component to a second component, in particular a cable to a carrier component of a motor vehicle, is provided. It comprises a plate-shaped base body having a sacrificial side and at least one or more energy directors arranged on the sacrificial side, wherein the energy director is approximately configured as a four-sided prism onto which a three-sided prism is molded.

### RELATED APPLICATIONS

The present application claims the benefit of German Patent Application Nos. 10 2024 122 999.3, filed Aug. 12, 2024, and 10 2025 131 484.5, filed Aug. 7, 2025, each titled “Sacrificial Plate, Fastening Device with such a Sacrificial Plate and Method for Fastening by Means of Such a Fastening Device,” the contents of which are hereby incorporated by reference.

### BACKGROUND

In plastic welding, maintaining clean and consistent welds is essential for ensuring strong, reliable joints. One common challenge is preventing contamination or damage to the heating elements during the welding process. To address this, a sacrificial plate is often used as a protective barrier between the plastic components and the hot plate or welding tool. This disposable plate helps absorb excess heat, prevents melted plastic from sticking to the equipment, and extends the lifespan of the welding tools, contributing to improved weld quality and easier maintenance.

Despite advancements, a need exists for an improved sacrificial plate for plastic welding as well as a fastening apparatus for fastening a first component to a second component, in particular a cable to a carrier component, as well as a method for fastening such a fastening apparatus. Such fastening apparatuses are configured as cable clips and comprise one or more receptacles for connecting one or more cables to a carrier component, in particular a motor vehicle.

### SUMMARY

The present disclosure generally relates to a sacrificial plate, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a schematic perspective view of a fastening apparatus according to the disclosure, having two fastening portions for receiving corresponding cables.

FIG. 2 illustrates a schematic perspective detail view of a sacrificial plate and a fastening portion according to a first exemplary embodiment.

FIG. 3 illustrates a schematic perspective detail view of the sacrificial plate and a fastening portion according to a second embodiment.

FIG. 4 illustrates a schematic perspective detail view of the sacrificial plate and a fastening portion according to a third embodiment.

FIG. 5 illustrates a schematic perspective view of the fastening apparatus of the disclosure, having two fastening portions for receiving corresponding cables according to the third exemplary embodiment.

FIG. 6 illustrates a further schematic perspective view of the fastening apparatus of the disclosure, having two fastening portions for receiving corresponding cables according to the third exemplary embodiment.

FIG. 7 illustrates a further schematic perspective view of the fastening apparatus of the disclosure, having two fastening portions for receiving corresponding cables according to a fourth exemplary embodiment.

FIG. 8 illustrates a schematic side detail view of the fastening apparatus according to the disclosure, having a fastening portion for receiving corresponding cables according to the exemplary embodiments.

FIG. 9 illustrates a schematic view of an energy director of a sacrificial plate known from the prior art.

FIG. 10 illustrates a schematic perspective view of an energy director according to the present disclosure.

FIG. 11 illustrates a comparison between sacrificial plates known from the prior art, a sacrificial plate known from the prior art, and a sacrificial plate according to the present disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a sacrificial plate for plastic welding as well as a fastening apparatus for fastening a first component to a second component, in particular a cable to a carrier component, as well as a method for fastening such a fastening apparatus.

Such fastening apparatuses are configured as cable clips and comprise one or more receptacles for connecting one or more cables to a carrier component, in particular a motor vehicle.

The cable clips are configured in two parts and comprise the cable clip itself as well as one or more sacrificial plates that can be inserted into the cable clip. To assemble such cable clips, the sacrificial plates must be inserted manually or automatically into corresponding recesses of the cable clip prior to use.

The sacrificial plates are configured so as to be flat. One or more energy directors are arranged on one side of the sacrificial plate. These energy directors have the shape of an isosceles or equilateral triangle in cross-section.

The number of corners of the base surface of prisms determines its designation.

The base surface and the top surface are parallel to one another and are polygons.

If the base surface is a triangle, it is called a three-sided Pr (a Pr with a triangle as the base surface has 3 rectangles as the lateral surface).

If the base surface is a quadrilateral, then it is called a four-sided Pr (a Pr with a quadrilateral as the base surface has 4 rectangles as the lateral surface).

If the base area is a pentagon, it is called a five-sided Pr (a Pr with a pentagon as the base area has 5 rectangles as the lateral surface), etc.

It is thus named according to its base surface (cross-sectional area).

Two equal surfaces are not automatically base and top surfaces.

The distance between the base and the top surface (=body height) is the same length at each point of the prism.

The given polygon is referred to as the base surface, and the other boundary surface which is congruent and parallel thereto is referred to as the top surface. The entirety of all remaining boundary surfaces is called the lateral surface. This consists of parallelograms, or, in the special case of the straight prism, rectangles.

The problem addressed by the present disclosure is to provide a sacrificial plate for plastic welding as well as a fastening apparatus for fastening a first component to a second component, in particular a cable to a carrier component of a motor vehicle, which enables easier handling and use.

A further problem addressed by the present disclosure is to form a sacrificial plate as well as a fastening apparatus having such a sacrificial plate, which allows for a safer and reliable connection of the fastening apparatus, in particular the sacrificial plate, to a corresponding component or a cable.

In addition, a problem addressed by the present disclosure to provide a sacrificial plate for plastic welding as well as a fastening apparatus having such a sacrificial plate, which represents an alternative to apparatuses known from the prior art.

One or more of these problems are solved by the features of the independent claims 1, 5, and 10. Advantageous configurations are specified in the respective dependent subclaims.

According to the disclosure, a sacrificial plate for plastic welding, in particular for a fastening apparatus for fastening a first component to a second component, in particular a cable to a carrier component of a motor vehicle, is provided. It comprises a plate-shaped base body having a sacrificial side and at least one or more energy directors arranged on the sacrificial side, wherein the energy director is approximately configured as a four-sided prism onto which a three-sided prism is molded, wherein a base surface of the four-sided prism is configured as an isosceles trapezoid and forms a first portion of a first end wall of the energy director, wherein the other boundary surface which is congruent and parallel thereto is a top surface forming a first portion of a second end wall of the energy director, and wherein the remaining boundary surfaces form a rectangular first floor wall in the region of the base body, a rectangular ceiling wall parallel thereto, and two rectangular first portions of a first and a second side wall of the energy director that are inclined in relation to the base body, and wherein a base surface of the three-sided prism is configured as an isosceles triangle and forms a second portion of the first end wall of the energy director, wherein the other boundary surface which is then congruent and parallel thereto is a top surface forming a second portion of the second end wall of the energy director, and wherein the remaining boundary surfaces form a rectangular second floor wall in the region of the ceiling wall of the four-sided prism and two rectangular second portions of a first and a second side wall that are inclined in relation to the base body.

In the context of the present disclosure, a cable is understood to mean one or more cables or a cable harness, or also one or more fluid lines, in particular in an automotive vehicle.

In the fastening apparatuses known from the prior art, or cable clips (2K routing clip), corresponding sacrificial plates are configured flat. Furthermore, corresponding energy directors of the sacrificial plates have the shape of an isosceles or an equilateral triangle in cross-section.

It has been found that such flat or straight sacrificial plates and/or energy directors in the form of an isosceles or equilateral triangle in cross-section require a high degree of accuracy during assembly in order to securely and reliably connect a cable to the fastening apparatus, often leading to insufficient connections, because the corresponding tolerances are not sufficient.

Corresponding sacrificial plates are melted by plastic welding, in particular by ultrasonic welding, in order to connect the energy director and the sacrificial plate to a cable to be fastened or to a corresponding portion of such a cable. Due to the fact that in the prior art, such energy directors are configured in the form of an isosceles or equilateral triangle, they have a melting portion in cross-section that requires a relatively high energy input due to its high volume in order to completely melt it and thus to form a secure connection between a cable clip and a cable.

In the sacrificial plate according to the disclosure, the energy director(s) are approximately configured as a four-sided prism onto which a three-sided prism is molded.

In this way, the energy director has two different melting portions in cross-section, which however have a lower volume or a lower material accumulation. This makes it easier to melt a sacrificial plate according to the disclosure, in particular its energy director.

In addition, no exact parallelism between the body to be fastened and the sacrificial plate is necessary, because a greater parallelism and thus also a safer and more reliable connection can be formed due to the easier energy input into the lower volume of the two melting portions compared to a single such melting portion with energy directors known from the prior art.

This means: With known energy directors, these are melted until the region of the largest volume is reached. It is often the case that the energy director is only partially melted and there remains unmelted or not completely melted material of the energy director, which cannot then be used for connecting the fastening apparatus to a corresponding cable.

In addition, the cable to be received and the corresponding energy director must be arranged extremely parallel to one another.

According to the disclosure, however, it is provided that the energy director deviates from the shape of an isosceles or equilateral triangle, or does not have such a shape in cross-section, such that by providing a four-sided and a three-sided prism in cross-section, two regions with a smaller material accumulation are formed that can be melted much more easily.

The energy director can thus be melted completely in a simple manner as well as safely and reliably in the two melting regions, so that a corresponding connecting region for connecting to a cable is formed more evenly. In this way, it is also not necessary to arrange the sacrificial plate and the receiving cable particularly parallel to one another, because the sacrificial plate and in particular the energy directors compensate such inaccuracies or non-parallelisms.

In particular, the sacrificial plate is part of a fastening apparatus manufactured by means of a 2-component injection molding process. The energy director (first component) according to the disclosure compensates for the imperfections of the entire fastening apparatus (second component), so that tight manufacturing tolerances are no longer necessary.

Furthermore, a sacrificial plate according to the disclosure can be replaced in a simple manner in order to adapt the fastening apparatus or the adhesion of the sacrificial plate to different conduction materials (e.g. PA12, PA6, TPE, etc.).

The one or more energy directors can comprise one or more interruptions in the longitudinal direction, such that the energy director(s) are segmented in form.

Due to the optimization or changing of the volume or shape of the energy director according to the disclosure, several advantages are achieved. Due to the changed volume, when the energy director is welded to a cable or pipe to be received, the energy input of the same or a lower amount of energy is achieved compared to the prior art. Nevertheless, more melt is produced or formed, so that a better connection is produced when welding.

This is because the interruption or the segmented energy director does not lead to over-welding in the region of the interruption. This means that it is safely and reliably prevented that too much energy input or too much melting power occurs in the center of the energy director, so that a pipe itself would be melted and damaged.

The one interruption can preferably be arranged in the center of the energy director(s).

Two or three or four or five or six or more energy directors can be provided, being arranged parallel to one another.

The sacrificial side of the energy director is preferably curved, wherein the curvature corresponds approximately to the curvature of a cross-section of a component to be received, such that the tip(s) of the energy director face towards the center of the cross-section of a cable to be received.

Alternatively, it can also be provided that the sacrificial plates are configured flat.

The two rectangular first portions of the first and second side wall of the energy director inclined in relation to the base body can be inclined in relation to the plate-shaped base body or conversely at a flatter angle than the two rectangular second portions of the first and second side wall inclined in relation to the base body.

The sacrificial plate can preferably be made from PA12, PA6 or TPE. In particular, it is provided that the material of the sacrificial plate is correspondingly adapted to the material of a cable or component to be received in such a way that a safe and reliable connection is possible by means of welding, in particular by means of ultrasonic welding.

Furthermore, on at least one edge region of the sacrificial plate, there can be a retaining contour for receiving in an undercut manner in a correspondingly configured recess of a fastening apparatus.

By providing such a retaining contour, the sacrificial plate can be connected to a corresponding fastening apparatus during manufacture or even thereafter in a non-releasable manner.

In this way, a corresponding fastening apparatus can be used immediately in a pre-assembly position without the need for further work steps, e.g. insertion of the sacrificial plate into the fastening apparatus prior to assembly.

Thus, the sacrificial plate according to the disclosure presents an alternative to the sacrificial plates known from the prior art due to the technical features described above.

Furthermore, the sacrificial plate can also be easily replaced in order to conform to suitably different materials of cables.

Furthermore, according to the present disclosure, a fastening apparatus, in particular a cable clip, is provided for fastening a first component to a second component, in particular a cable to a carrier component of a motor vehicle, preferably with a sacrificial plate described above. It comprises a fastening body having a recess for receiving a sacrificial plate for plastic welding, and a sacrificial plate arranged in the recess and weldable by means of plastic welding, in particular by means of ultrasonics, wherein the sacrificial plate is connected in a non-releasable manner to the fastening body in a pre-assembly position by means of a form-fit and/or force-fit and/or friction-fit connection.

The fastening apparatus according to the disclosure thus has the advantage that the sacrificial plate is connected in a non-releasable manner to the fastening body of the fastening apparatus, in particular already in a pre-assembly position during manufacture.

The advantages of the fastening apparatus according to the disclosure correspond analogously to the advantages described above based on the sacrificial plate according to the disclosure.

The sacrificial plate can comprise a retaining contour along at least one lateral edge region, which can be received in a form-fit manner in a correspondingly configured undercut-like region of the recess.

In this way, the non-releasable, loss-proof connection between the fastening body and the sacrificial plate is ensured. Additionally, and/or alternatively, the sacrificial plate can be connected to the fastening body by means of force-fit and/or friction-fit connection.

The fastening body can preferably be made from PA66.

Some advantageous embodiments of the fastening apparatus are described below.

The fastening body of the fastening apparatus can be made from standard PA6 or PA6.6, and the sacrificial plate can be made from PA12. Thus, according to one embodiment, it is preferably provided that the sacrificial plate is made from a higher quality material than the sacrificial plate. Furthermore, the sacrificial plate can preferably be made from the same material as a pipe to be received in the fastening apparatus. Such a configuration of the fastening apparatus is particularly suitable for receiving a cable or a pipe made from PA12. This means that the material of the sacrificial plate can be configured for the material of a cable or pipe to be received, such that a secure and reliable connection between the fastening body and the cable or pipe to be received is ensured.

The fastening apparatus can alternatively also be configured as a single-part component.

The fastening body, comprising the fastening body and the sacrificial plate, can then be made integrally from PP including glass fiber contents, e.g. PPGF30. Such a configuration of the fastening apparatus is particularly suitable for receiving a cable or a pipe made from TPV.

The fastening body, comprising the fastening body and the sacrificial plate, can then be made integrally from PE. Such a configuration of the fastening apparatus is particularly suitable for receiving a cable or a pipe made from PE.

In the event of adhesion problems and/or stability problems with a PE pipe, the fastening apparatus can also be configured as a 2-part component, wherein the fastening body is then made of PP or PA6 and the sacrificial plate is made of PP, if necessary with glass fibers, e.g. PPGF30.

The fastening body, comprising the fastening body and the sacrificial plate, can then be made integrally from PA6. Such a configuration of the fastening apparatus is particularly suitable for receiving a cable or a pipe made from PA6.

The fastening body, comprising the fastening body and the sacrificial plate, can then be made integrally from POM. Such a configuration of the fastening apparatus is particularly suitable for receiving a cable or a pipe made from POM.

In the event of adhesion problems and/or stability problems with a POM pipe, the fastening apparatus can also be configured as a 2-part component, wherein the fastening body is then made of POM or PA6 and the sacrificial plate is made of TPU.

The fastening body can comprise at least one fastening portion for connecting to a second component, in particular a cable, and a receiving portion for connecting to a first component, in particular a carrier component of a motor vehicle.

Furthermore, two or more fastening portions are provided on the fastening body, wherein, in the region of each fastening portion, a portion of the sacrificial plate is arranged, wherein the at least two portions of the sacrificial plate can be connected to one another via a sacrificial plate connecting portion.

In this way, the fastening apparatus is easily manufactured and allows for a non-releasable connection of one or more sacrificial plates to a corresponding fastening body of the fastening apparatus.

Advantageously, the fastening apparatus can be manufactured from two different plastics by means of a two-component injection molding process.

In this way, the fastening apparatus, comprising the fastening body and the sacrificial plate, can be easily manufactured such that the sacrificial plate is connected in a non-releasable manner to the fastening body.

In addition, according to the present disclosure, a method for fastening by means of a fastening apparatus described above, in particular a cable clip, for fastening a first component to a second component, in particular a cable to a carrier component of a motor vehicle, is provided. It comprises the present steps: providing the fastening apparatus with at least one sacrificial plate that is connected in a non-releasable manner to the fastening apparatus in a pre-assembly position, inserting a cable into a fastening portion of the fastening apparatus, and connecting the cable to the fastening portion via the sacrificial plate by means of plastic welding, in particular by means of ultrasonics.

The advantages of the method according to the disclosure correspond analogously to the advantages described above based on the sacrificial plate according to the disclosure and the fastening apparatus according to the disclosure.

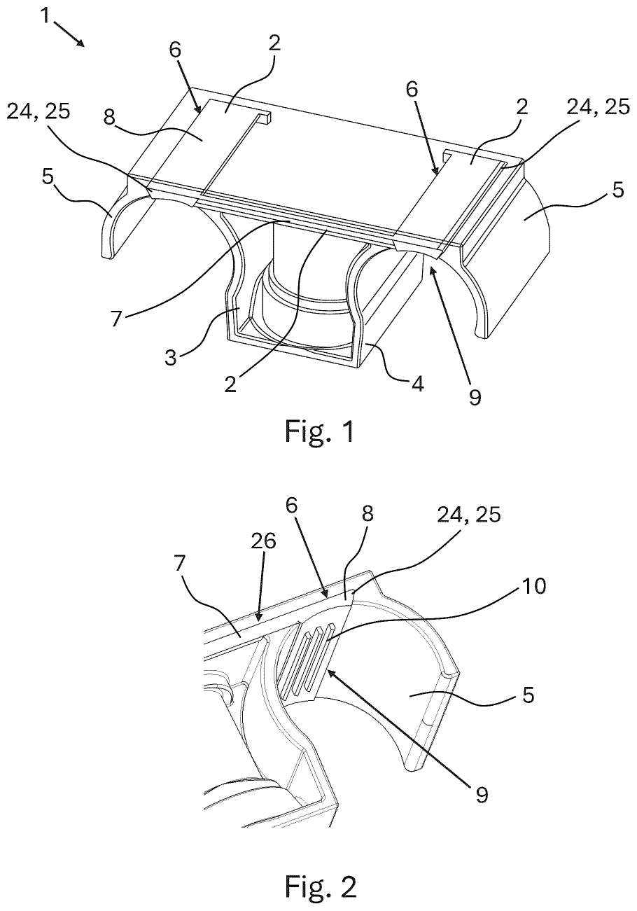

In the following, a fastening apparatus 1 according to the disclosure having a sacrificial plate 2 according to the disclosure is described in further detail (FIGS. 1 and 2). FIG. 1 illustrates a schematic perspective view of a fastening apparatus according to the disclosure, having two fastening portions for receiving corresponding cables, while c. 2 illustrates a schematic perspective detail view of a sacrificial plate and a fastening portion according to a first exemplary embodiment.

The fastening apparatus 1 is configured as a cable clip for fastening a first component to a second component, in particular a cable to a carrier component of a motor vehicle.

The fastening apparatus 1 comprises a fastening apparatus body 3 that is approximately T-shaped according to the present exemplary embodiment.

Furthermore, the fastening body 3 comprises a receiving portion 4, via which the fastening body 3 can be connected to a carrier component. The receiving portion 4 is configured as a bolt receptacle according to the present exemplary embodiment. However, the receiving portion 4 can also be configured for connecting in the form of any other fastening means, such as a locking, screwing, or otherwise configured connection.

According to the present exemplary embodiment, the fastening apparatus 1 is configured so as to receive two cables and accordingly comprises two half shell-shaped or annularly shaped fastening portions 5.

In the fastening portions 5, a respective recess 6 for receiving a sacrificial plate 2 is arranged.

The two recesses 6 are connected to one another via a melting channel 7, so that they can be manufactured or formed in a single working step by means of a 2-component injection molding method during the manufacture of the fastening apparatus 1.

The fastening body 3 is preferably made from PA66.

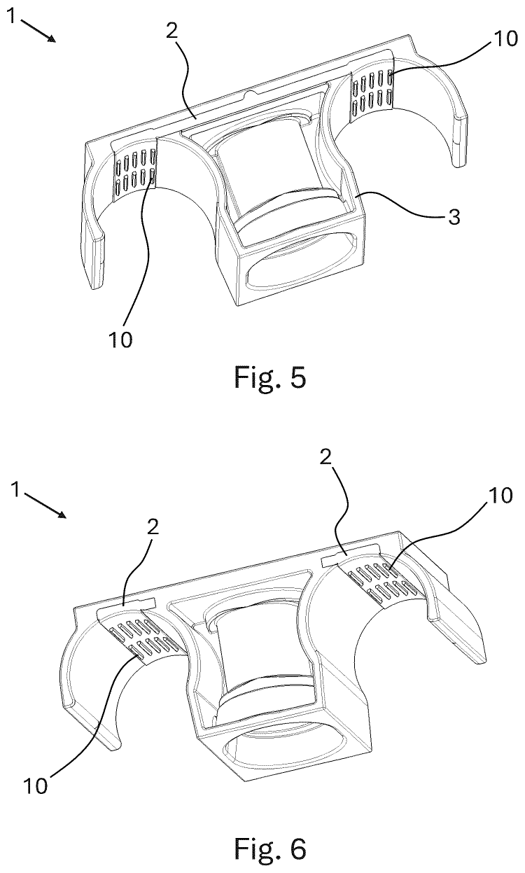

The following describes the sacrificial plates 2 and the sacrificial plate 2 in further detail (FIGS. 1-5).

The sacrificial plate 2 comprises an approximately plate-shaped base body 8 with a sacrificial side 9.

The sacrificial side 9 is configured so as curve in the direction of a cable to be received, wherein the curvature of the sacrificial side 9 corresponds approximately to the curvature of a component or a cable to be received.

A plurality of energy directors 10 are arranged on the sacrificial side 9.

Each of these energy directors 10 is approximately configured as a four-sided prism 11, onto which a three-sided prism 12 is molded.

A base surface of the four-sided prism 11 is formed as a isosceles trapezoid and forms a first portion 13 of a first end wall 27 of the energy director 10.

The other boundary surface which is congruent and parallel thereto is a top surface forming a first portion 14 of a second end wall 28 of the energy director 10.

The remaining boundary surfaces form a rectangular first floor wall 15 in the region of the base body 8, a rectangular ceiling wall 16 parallel thereto, and two rectangular first portions 17, 18 of a first and second side wall 29, 30 of the energy director that are inclined in relation to the base body 8.

A base surface of the three-sided prism 12 is configured as an isosceles triangle and forms a second portion 19 of the first end wall 27 of the energy director 10, wherein the other boundary surface which is congruent and parallel thereto is a top surface forming a second portion 20 of the second end wall 28 of the energy director 10.

The remaining boundary surfaces form a rectangular second floor wall 21 in the region of the ceiling wall 16 of the four-sided prism 11 and two rectangular second portions 22, 23 that are inclined in relation to the base body 8 of the first and second side wall 29, 30 that are inclined in relation to the base body 8.

The two rectangular first portions 17, 18 of the first and second side wall 29, 30 of the energy director 10 inclined in relation to the base body 8 are inclined in relation to the plate-shaped base body 8 at a flatter angle than the two rectangular second portions 22, 23 of the first and second side wall 29, 30 inclined in relation to the base body 8.

A retaining contour 24, which is approximately triangular in cross-section, is provided on an edge region of the sacrificial plate 2. This retaining contour 24 is used for the form-fit receiving connection or connection to a correspondingly configured recess 25 of the fastening apparatus 1.

Furthermore, the fastening body 3 comprises a melting channel recess 26, via which the two recesses 6 for receiving the sacrificial plates 2 are connected to one another.

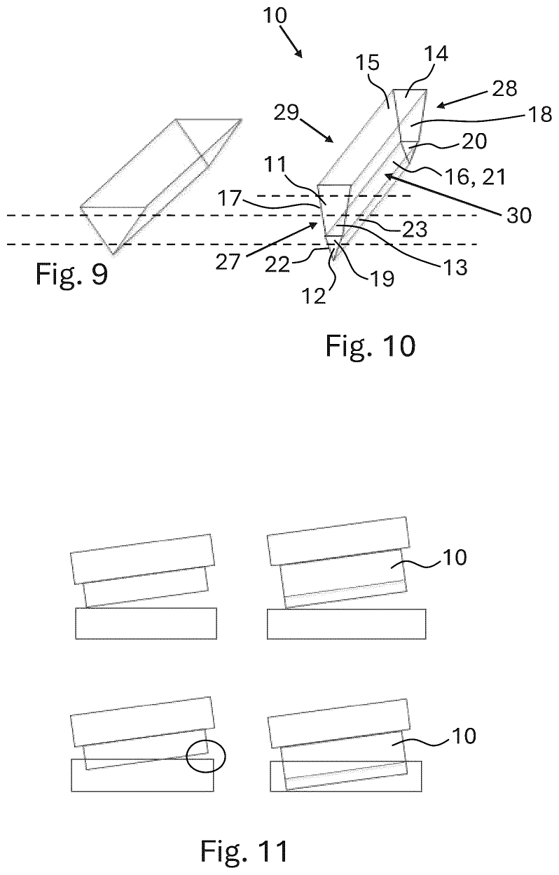

FIGS. 4 through 11 illustrate various aspects of the fastening apparatus and sacrificial plate according to multiple embodiments of the present disclosure. FIGS. 4 to 8 depict schematic views of the fastening apparatus, including detailed and perspective views of one or more fastening portions designed to receive corresponding cables in both third and fourth exemplary embodiments. FIGS. 9 and 10 compare energy directors, showing a prior art example and a new design according to the present disclosure. FIG. 11 presents a comparative view of sacrificial plates from the prior art alongside the improved sacrificial plate disclosed herein.

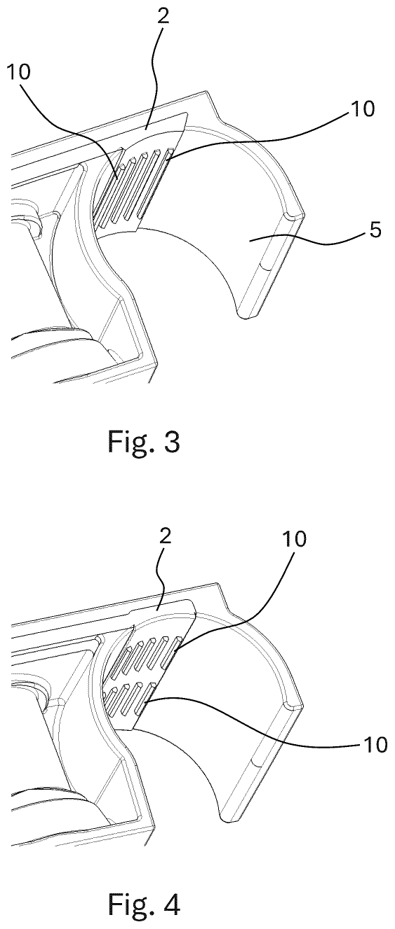

The energy directors known from the prior art have the shape of an isosceles or equilateral triangle in cross-section (FIG. 3).

Such energy directors comprise a region or portion having a high volume or a higher material accumulation, which accordingly requires a significantly higher energy input in order to melt it completely. However, in practice, this is not always safe and reliable, resulting in unreliable connections between cables and fastening apparatuses.

The energy director 10 according to the disclosure or a sacrificial plate 2 with corresponding energy directors 10 is configured in the form of a four-sided prism 11 and a three-sided prism 12 molded thereon, so that two melting ranges with lower material accumulation are created. These can be melted completely and reliably in a much easier manner, and in particular with a lower energy input. Accordingly, this leads to a safer and more reliable connection.

In known energy directors, these are mostly melted until the high volume melting range is reached. However, the energy director is usually only partially melted, so that unmolten material of the energy director remains. This means that a base body 8 of the energy director 10 of the sacrificial plate 2 and a component to be received must be arranged extremely flat and parallel to one another.

By contrast, it is provided according to the present disclosure that the energy director 10 can be melted much more easily due to the two different melting ranges in the region of the four-sided and three-sided prisms 11,12 due to the lower material accumulation. Welding energy can thus be used more efficiently in order to melt all of the material of the energy director 10, which also results in a more even welding surface.

In this way, the base body 8 of the sacrificial plate 2 and the energy director 10 compensate for corresponding imperfections.

In the following, alternative exemplary embodiments of the sacrificial plate 2 according to the disclosure will be described according to a second, a third, and a fourth exemplary embodiment. Unless otherwise described, these exemplary embodiments have the same technical features as the sacrificial plate according to the first exemplary embodiment (FIGS. 3 to 8).

The one or more energy directors 10 can comprise one or more interruptions in the longitudinal direction, such that the energy director(s) 10 are segmented in form.

The one interruption can preferably be arranged in the center of the energy director(s) (FIGS. 4 to 7).

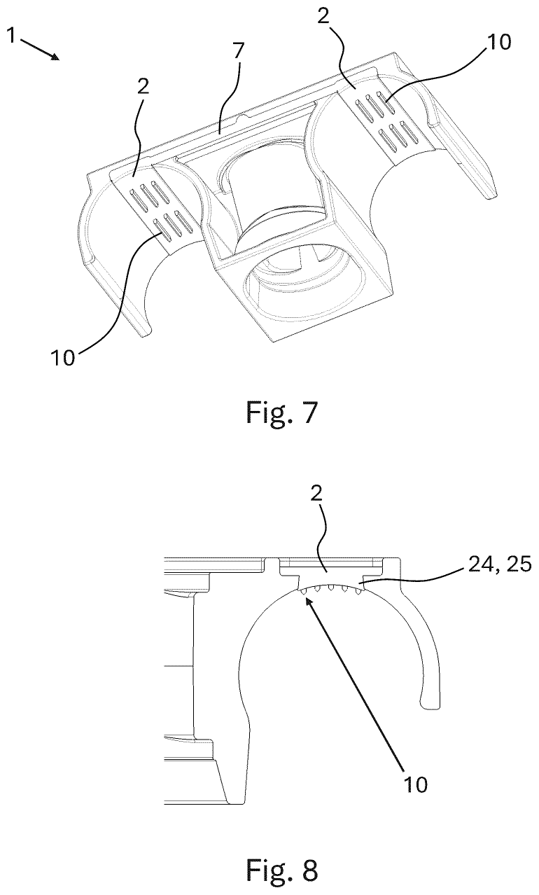

Two or three (FIGS. 2 and 7) or four or five (FIGS. 3-5 and FIG. 8) or six or more energy directors can be provided, being arranged parallel to one another.

In FIG. 9, an energy director according to the prior art is shown. In FIG. 10, an energy director 10 according to the disclosure is shown. The energy director according to the disclosure can generally have the same volume as an energy director known from the prior art.

In the region of the tips (below the third dashed line), both energy directors have a first low volume region at which only little energy is needed for melting.

The energy director (FIG. 9) known from the prior art comprises a second region (between the second and the third dashed line) that has a large volume and therefore requires a high energy input for melting.

By contrast to this second region, the energy director according to the disclosure comprises a second region (between the second and the third dashed line) and a third region (above the first dashed line). The second and third regions of the energy director 10 according to the disclosure each have a lower volume and an average volume, respectively, compared to the second region of the energy director of the prior art, which in comparison require less energy for melting.

This correlation during welding is also shown schematically in FIG. 11. An energy director known from the prior art melts until the second high volume region is reached. In this second region, the energy director melts only partially or not completely. Thus, unmolten material remains. This leads to the fact that energy directors known from the prior art must be configured flat.

The energy director 10 according to the disclosure is lighter due to its lower volume. The introduced welding energy melts more material. This results in the welding region being more evenly formed. In addition, there is the advantage that imperfections between the sacrificial plate and the object to be received can be compensated.

Furthermore, according to the present disclosure, a method for fastening by means of a fastening apparatus described above, in particular a cable clip, for fastening a first component to a second component, in particular a cable to a carrier component of a motor vehicle, is provided. It comprises the present steps: providing the fastening apparatus with at least one sacrificial plate that is connected in a non-releasable manner to the fastening apparatus in a pre-assembly position, inserting a cable into a fastening portion of the fastening apparatus, and connecting the cable to the fastening portion via the sacrificial plate by means of plastic welding, in particular by means of ultrasonics.

While the present device and/or system have been described with reference to certain examples, it will be understood by those skilled in the art that various changes may be made and equivalents may be substituted without departing from the scope of the present device and/or system. In addition, many modifications may be made to adapt a particular situation or material to the teachings of the present disclosure without departing from its scope. For example, components of disclosed examples may be combined, divided, re-arranged, and/or otherwise modified. Therefore, the present device and/or system are not limited to the particular examples disclosed. Instead, the present device and/or system will include all examples falling within the scope of the appended claims, both literally and under the doctrine of equivalents.

### LIST OF REFERENCE NUMERALS

1 Fastening apparatus
2 Sacrificial plate
3 Fastening body
4 Receiving portion
5 Fastening portion
6 Recess
7 Melting channel
8 Base body
9 Sacrificial side
10 Energy director
11 Four-sided prism
12 Three-sided prism
13 First portion, first end wall
14 First portion, second end wall
15 First floor wall
16 Ceiling wall
17 First portion, first side wall
18 First portion, second side wall
19 Second portion, first end wall
20 Second portion, second end wall
21 Second floor wall
22 Second portion, first side wall
23 Second portion, second side wall
24 Retaining contour
25 Recess
26 Melting passage recess
27 First end wall
28 Second end wall
29 First side wall
30 Second side wall

What is claimed is:

1. A sacrificial plate for plastic welding for a fastening apparatus for fastening a first component to a second component comprising
a plate-shaped base body having a sacrificial side, and
at least one or more energy directors arranged on the sacrificial side, wherein the energy director is approximately configured as a four-sided prism onto which a three-sided prism is molded,
wherein a base surface of the four-sided prism is configured as an isosceles trapezoid and forms a first portion of a first end wall of the energy director, wherein the other boundary surface which is congruent and parallel thereto is a top surface forming a first portion of a second end wall of the energy director, and wherein the remaining boundary surfaces form a rectangular first floor wall in the region of the base body, a rectangular ceiling wall parallel thereto, and two rectangular first portions of a first and second side wall of the energy director that are inclined in relation to the base body, and
wherein a base surface of the three-sided prism is configured as an isosceles triangle and forms a second portion of the first end wall of the energy director, wherein the other boundary surface which is congruent and parallel thereto is a top surface forming a second portion of the second end wall of the energy director, and wherein the remaining boundary surfaces form a rectangular second floor wall in the region of the ceiling wall of the four-sided prism and two rectangular second portions of a first and second side wall that are inclined in relation to the base body.

2. The sacrificial plate according to claim 1,
wherein the two rectangular first portions of the first and second side wall of the energy di-rector inclined in relation to the base body are inclined in relation to the plate-shaped base body at a flatter angle than the two rectangular second portions of the first and second side wall inclined in relation to the base body.

3. The sacrificial plate according to claim 1,
wherein the one or more energy directors comprise one or more interruptions in the longitudinal direction, such that the energy director(s) are segmented in form.

4. The sacrificial plate according to claim 1,
wherein the base body is curved in form, and
wherein the curvature corresponds approximately to the curvature of a cross-section of a component to be received, such that the tip(s) of the energy director face towards the center of the cross-section of a cable to be received.

5. The sacrificial plate according to claim 1,
wherein on at least one edge region of the sacrificial plate, there is a retaining contour for receiving in an undercut manner in a correspondingly configured recess of a fastening apparatus.

6. A fastening apparatus for fastening a first component to a second component a cable on a carrier component of a motor vehicle, preferably comprising a sacrificial plate according to claim 1, comprising
a fastening body having a recess for receiving a sacrificial plate for plastic welding, and
a sacrificial plate arranged in the recess and weldable by means of plastic welding,
wherein the sacrificial plate is connected in a non-releasable manner to the fastening body in a pre-assembly position by means of a form-fit and/or force-fit and/or friction-fit connection.

7. The fastening apparatus according to claim 6,
wherein the sacrificial plate comprises a retaining contour along at least one lateral edge region, which is received in a form-fit manner in a correspondingly configured undercut-like region of the recess.

8. The fastening apparatus according to claim 6,
wherein the fastening body comprises at least one fastening portion for connecting to a second component, and a receiving portion for connecting to a first component.

9. The fastening apparatus according to claim 8,
wherein two or more fastening portions are provided, wherein, in the region of each fastening portion, a portion of the sacrificial plate is arranged, wherein the at least two portions of the sacrificial plate are connected to one another via a melting channel.

10. A method for fastening by means of a fastening apparatus according to any one of claim 5 for fastening a first component to a second component, comprising the following steps:
providing the fastening apparatus with at least one sacrificial plate that is connected in a non-releasable manner to the fastening apparatus in a pre-assembly position,
inserting a cable into a fastening portion of the fastening apparatus, and
connecting the cable to the fastening portion via the sacrificial plate by means of plastic welding.
